(19) United States
(12) Patent Application Publication
(10) Pub. No.: US 2006/0130228 A1
(43) Pub. Date: Jun. 22, 2006

(54) Bathing device having a heated shell

(76) Inventors: Bernard Lebrun, St-Joseph-de-Levis (CA); Nicolas Lebrun, St-Isidore (CA); Daniel Cass Sholl, Apple Valley, MN (US); Kevin G. Maas, Crystal, MN (US); Steve Rouleau, Ste-Marie-de-Beauce (CA); Luca Serli, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/012,306

(22) Filed: Dec. 16, 2004

(51) Int. Cl. A61H 33/02

(52) U.S. Cl. 4/545

(57) ABSTRACT

A bathing device, such as a bathtub, a tub shower, a shower, a spa and a pool, comprises a substantially iron-free shell and at least one heating pad in direct conductive heat exchange contact with the shell. It also relates to a method for manufacturing a heated bathing device.

### BACKGROUND OF THE INVENTION

1) Field of the Invention

The present invention relates to bathing devices and, more specifically, to bathing devices having a heated shell and to a method to heat the shell of a bathing device.

2) Description of the Prior Art

Soaking in a bathtub filled with warm water produces relaxing effects on the human body. To be pleasant, water is usually above 26° C., which is warmer than ambient air. Thus, the water slowly cools down producing displeasing effects on the bathtub's user. To warm up the bathtub water, the user usually releases bathtub water to add new water which is warmer than the one released. This process presents several disadvantages. This is not ecologically friendly since drinkable water is wasted. Moreover, it is more expensive to warm water from the waterworks system than water at the ambient temperature. Thus, there is a need to maintain the temperature of the water contained in the bathtub at a constant temperature and have a warm shell in contact with the user's body for more enjoyable sensation. However, the combination of electricity and water is not usually considered a safe mix.

U.S. Pat. Nos. 1,389,050, 1,941,832, and 2,301,761 describe bathtubs having a heating system located under the shell in a heating chamber. In these cases, the heating system heats the air located in the chamber and, thus, indirectly the bathtub. This is not an energetically efficient system since an important volume of air needs to be heated to transmit air to the bathtub shell by convection and, then, the heat needs to be transmitted through the bathtub shell by conduction. For an improved heat transfer, these systems require a blower for an increased air circulation. U.S. Pat. No. 3,157,774 describes a bathtub for physiological heat treatment. The bath is a double container having an outside shell and an inside shell. A heat exchange liquid and a heating element are located between the outside and the inside shells to indirectly heat the treatment liquid. As for the above-mentioned patents, this is not an energetically efficient system since the heat transfer occurs through a second liquid that has to be heated. Moreover, the system requires an agitator from an improved heat transfer and it is impossible to enjoy the heat benefit without using the therapeutic system.

U.S. Pat. No. 1,669,773 describes a bathtub having an electrically heated bottom or heated walls. The object of this invention is to dispose heated coils against the exterior surface of the bathtub shell. However, the surface where the heated coils are disposed must be made of metal to prevent deformation and conduct heat. Similarly, U.S. Pat. No. 3,108,170 describes a heating element directly mounted on the steel core of the bathtub. The heating element comprises a resin coating, such as Teflon™ applied on the outside surface of the bathtub shell, a metallic resistor applied on the resin coating, and a silicon varnish layer covering the metallic resistor. Actual bathtubs do not have a steel core and are usually made of acrylic or fiberglass. It would be difficult, almost impossible, to apply the heating element of U.S. Pat. No. 3,108,170 directly on the surface of a modern bathtub.

### SUMMARY OF THE INVENTION

It is an object of the invention to provide a new method and apparatus to maintain warm water inside bathing devices and provide a warm shell. The method is intended to be easily adaptable to usual production lines and safe.

One aspect of the invention provides a bathing device comprising a substantially iron-free shell; and at least one flexible heating pad in direct conductive heat exchange contact with the shell.

Another aspect of the invention provides a heating source in combination with a bathing device having a substantially iron-free shell with an outer surface, the heating source being in a fluid gap free contact with the outer surface and being adapted to provide heat thereto by heat conduction.

A further aspect of the invention provides a method for manufacturing a heated bathing device having a plastic shell the method comprising the steps of adhesively applying at least one flexible heating source in direct contact conductive heat exchange with at least one section of the shell.

### BRIEF DESCRIPTION OF THE DRAWINGS

Further features and advantages of the present invention will become apparent from the following detailed description, taken in combination with the appended drawings, in which:

FIG. 1. is a perspective view of a bathtub shell having a heating membrane laminated on its outer surface in accordance with an embodiment of the present invention;

FIG. 2 is an exploded perspective view of the bathtub shell with the heating membrane of FIG. 1; and

FIG. 3 is a perspective view, partly sectioned, of a shower having a heating membrane disposed under a flooring surface in accordance with another embodiment of the present invention.

It will be noted that throughout the appended drawings, like features are identified by like reference numerals.

### DETAILED DESCRIPTION OF THE PREFERRED EMBODIMENT

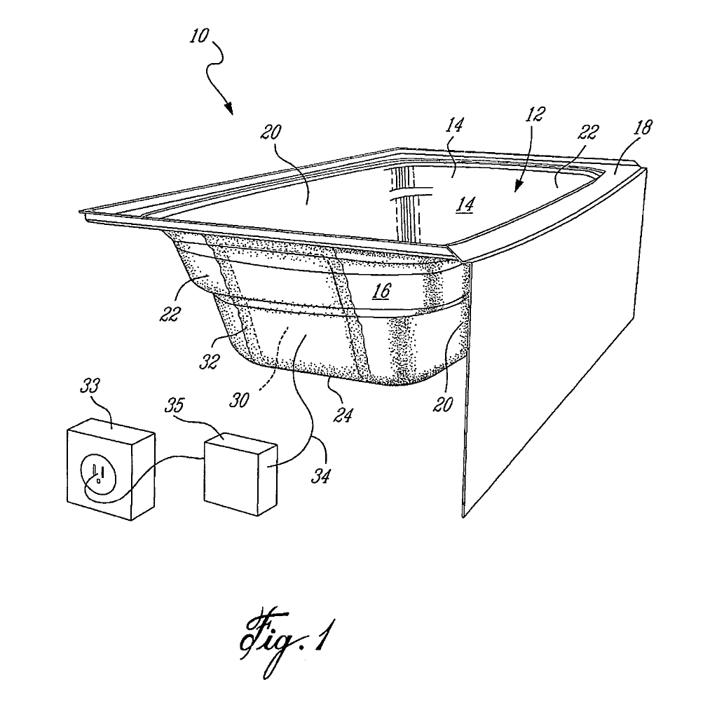

Referring to FIG. 1, there is shown that a bathing device such as a bathtub 10, either a conventional or an hydromassage bathtub, has a shell 12 adapted to contain a pool of water (not shown). The bathtub shell 12 has an inner face 14, an outer face 16, and a surrounding rim 18. The shell 12 shown on FIG. 1 has two vertical longitudinal walls 20, two vertical transversal walls 22, and a bottom surface 24. The bathtub shell 12 can be made of any appropriate plastic material (thermoset or thermoplastic type) known by one skilled in the art such as acrylic, acrylic reinforced with fiberglass, fiberglass, gelcoat reinforced with fiberglass, ABS acrylic, ABS reinforced or not with fiberglass, acrylic-ABS co-extrusion sheet molding compound or similar close mold process, any material defined in ANSI Z124 standard series and CSA B45 (Plumbing fixtures), and the like.

For heating or keeping the pool of water contained in the shell 12 at a predetermined temperature, a heating membrane 30, or a heating pad or mat, preferably flexible, is mounted to the outer face 16 of the shell 12. The heat generated by the membrane 30 is transmitted by direct conduction to the shell 12 and then to the pool of water contained therein.

Referring to FIG. 1, it will be seen that the membrane 30 is mounted to both vertical transversal walls 22 and the bottom surface 24 of the shell 12. However, it is appreciated that the membrane 30 can be mounted on any wall or surface of the shell 12 and that the shell 12 can include more than one membrane 30. For example, it can be disposed proximate to the armrests, the seats or the backrests. To provide energy to heat the membrane 30 and subsequently the shell 12, the membrane 30 is operatively connected to a power supply 33 through an electric wire 34.

The heating membrane 30 can be operatively connected to an electronic control system 35 or any control device to control the operation of the membrane 30 such as the on/off operation and the heat level provided to the shell 12. The control system can be operatively connected to a touchpad display (not shown). The touchpad gives the opportunity to the user to start the heating system and select the desired intensity. If several membranes 30 are mounted to the shell 12, each membrane 30 can preferably be controlled independently.

The membrane 30 can be mounted to the shell 12 in several ways. For example, an acrylic plastic sheet can be thermoformed into a predetermined shape and then placed on a jig support. Fiberglass is sprayed on the outer surface of the thermoformed part to reinforce the shell 12. Then one or several membranes 30 are then applied at predetermined locations on the outer surface 16 over the wet fiberglass and an additional layer 32 of fiberglass is sprayed over to firmly maintain the membranes 30 thereon, protect the membrane 30 from outside elements, and prevent access thereto for safety reasons. The membrane 30 is thus encapsulated between two polymeric membranes. A person skilled in the art will appreciate that other materials than fiberglass can be used to reinforce the shell 12 and cover the membrane 30. The outer layer is however not compulsory.

The membrane 30 can include a heating layer 37 covered by a conductive material pocket to ground the membrane 30 and provide an increased security for the bather who is resting in the heated bathing device 10. For example, the membrane 30 can include a 3/1000 inch aluminum foil pocket. Other conductive material pockets such as copper and brass can be used. Moreover, the thickness of the conductive material pocket can vary. The heating layer 37 can be inserted into the conductive material pocket before being applied to the shell 12 or can be mounted between two conductive material sheets while being mounted to the shell 12.

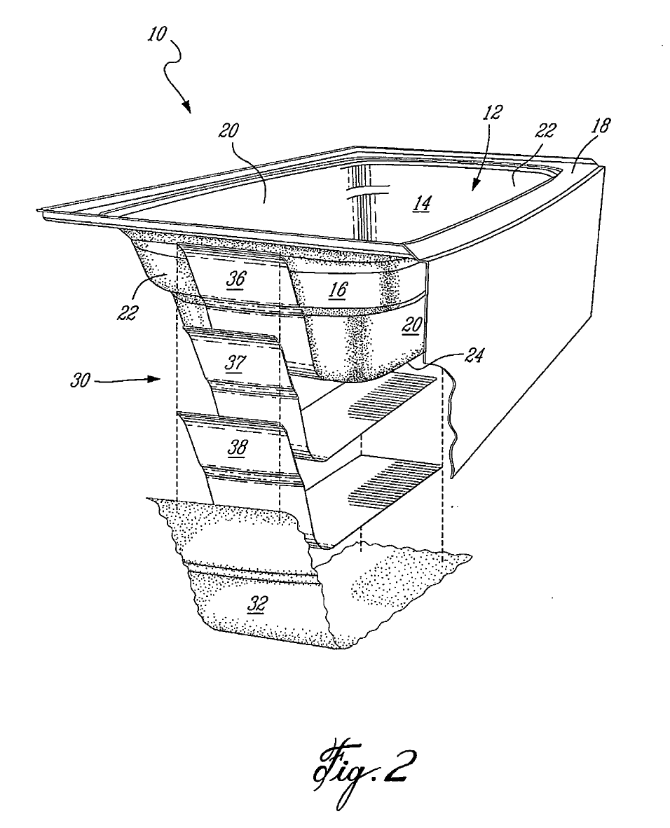

For example, referring to FIG. 2, it will be seen that a first sheet 36 of conductive material is first mounted to the shell 12, the heating layer 37 is then adhesively applied to the first sheet 36 of conductive material and is covered by a second sheet 38 of conductive material. The conductive material sheets 36, 38 or pocket can be mounted to the shell 12 with fasteners or any other means known to one skilled in the art but are preferably adhesively mounted thereto.

Self-adhesive conductive material sheets 36, 38 and heating layers 37 can be provided to facilitate their adhesion either to the shell 12, to the conductive material sheet 36, 38 or to the heating layer 37. A pressure-sensitive adhesive, epoxy or cement can also be used to mount the heating layer 37 or the conductive material sheets 36, 38 to the shell 12.

After the membrane 30 has been mounted to the shell 12, a second layer, such as a fiberglass layer, can be applied. Additional layers (not shown) can also be provided over the membrane 30 to prevent heat losses in the ambient air and increase the energy efficiency of the heat transfer process.

The voltage of the membrane 30 can be any value that does not provide any danger for the bather. For example, for Canada and United States, the voltage of the membrane 30 can be 110 and 120 volts. For Europe, the voltage can be 220 and 240 volts. It is also possible to use lower or higher values depending on the user's needs. Preferably, the membrane 30 has typically a rating of 120 watts or below. The maximum temperature reached by the shell 12 is below 95° C., preferably below 85° C.

Several types of heating membrane 30 can be used such as wire or foil elements embedded within a pad or mounted to a membrane. For example, it can consist in an etched foil resistive element laminated between layers of flexible material.

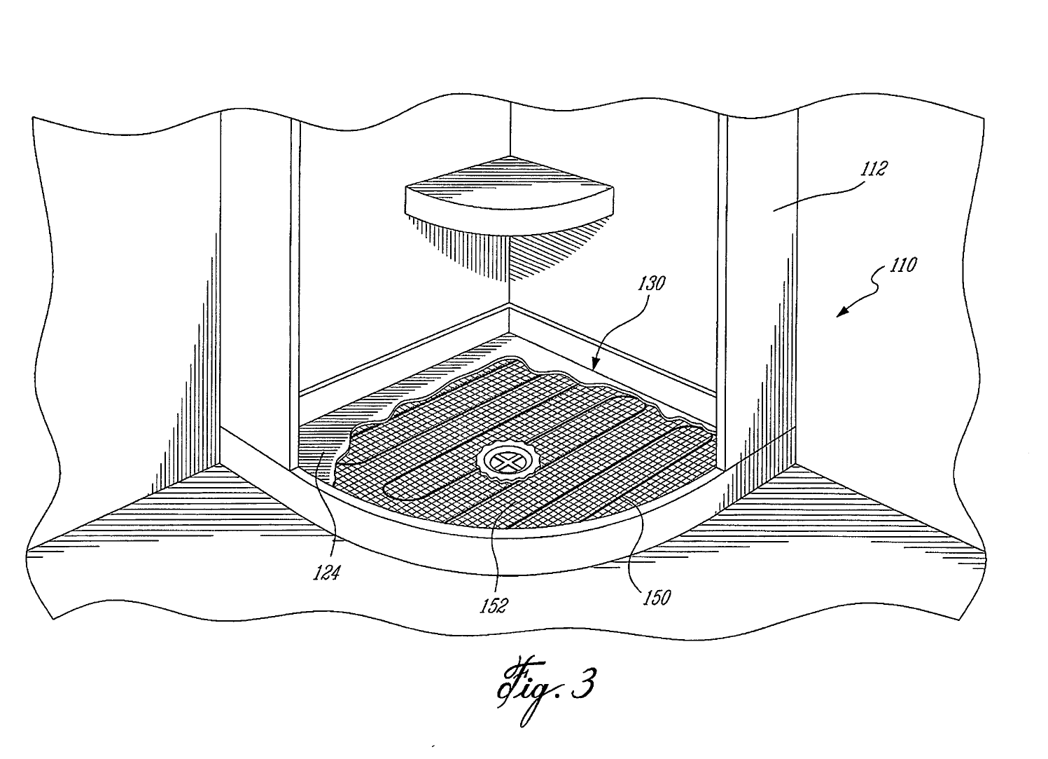

Referring to FIG. 3, it will be seen that a membrane 130 developed for floor heating systems can also be used. The heating membrane 130 includes a cable 150 mounted to a mat 152 such as a polymeric mat or a metallic mat, which can be a self-adhesive mat for easily mounting the membrane 130 to the shell 112. In addition to a heating wire (not shown), the cable 150 can include a ground wire for an increased security and an insulation wire (not shown). The mat 152 is unrolled and applied, preferably adhesively, to the shell 112. In FIG. 3, the membrane 130 is mounted to the bottom surface 124 of a shower 110.

One skilled in the art will also appreciate that the membrane 130 can include conductive material sheets 36, 38 or be laminated between fiberglass layers.

Nickel coated carbon fibers laminated in thermoplastic, elastomeric, composite or other sheet films can also be used as membranes 30, 130.

The membrane 30, 130 preferably provides a uniform heat distribution. It is also preferable to mount the membrane 30, 130 to the shell 12, 112 in a manner such that it is in intimate contact all over the surface beneath, or in fluid gap free contact, as any gaps can block heat transfer. Therefore, membranes 30, 130 that are flexible and can fit many sizes and shapes are preferable.

The heating membrane 30, 130 can be applied to other bathing devices than bathtubs and shower floors. For example, it can be applied to any shower wall, pools, shower or bath seats, tub showers, spas, and the like.

The membranes 30, 130 applied on the bathing devices allow to maintain the water at a constant temperature. They also provide a warm shell in contact with the user's body for more enjoyable sensation. It also provides muscular relaxing effect. The relaxing and enjoyable heat effect can be increased by applying more heat in predetermined areas of the shell.

The embodiments of the invention described above are intended to be exemplary only. For example, the heating membrane 30, 130 can be applied to already existing bathing devices or can be mounted to the bathing device shell by the manufacturer. The scope of the invention is therefore intended to be limited solely by the scope of the appended claims.

We claim:

1. A bathing device comprising a substantially iron-free shell; and at least one flexible heating pad in direct conductive heat exchange contact with the shell.

2. A bathing device as claimed in claim 1, wherein said bathing device has an outer face and said at least one heating pad is laminated over a predetermined area of the outer face of the shell.

3. A bathing device as claimed in claim 1, comprising a protective layer applied over said at least one heating pad.

4. A bathing device as claimed in claim 3, wherein said protective layer includes fiberglass.

5. A bathing device as claimed in claim 1, wherein said at least one heating pad comprises at least one covering conductive sheet.

6. A bathing device as claimed in claim 5, wherein said at least one heating pad comprises a covering conductive pocket.

7. A bathing device as claimed in claim 1, wherein said bathing device is selected from the group consisting of: a bathtub, a tub shower, a shower, a spa and a pool.

8. A heating source in combination with a bathing device having a substantially iron-free shell with an outer surface, said heating source being in a fluid gap free contact with the outer surface and being adapted to provide heat thereto by heat conduction.

9. A combination as claimed in claim 8, wherein said heating source is flexible.

10. A combination as claimed in claim 8, wherein said heating source comprises a heating membrane laminated on said outer surface.

11. A combination as claimed in claim 8, comprising a protective layer applied over said heating source.

12. A combination as claimed in claim 11, comprising said protective layer includes fiberglass.

13. A combination as claimed in claim 8, wherein said heating source comprises at least one covering conductive sheet.

14. A combination as claimed in claim 8, wherein said heating source comprises an electric cable attached to a fiberglass mat.

15. A combination as claimed in claim 8, wherein said heating source comprises nickel coated carbon fibers laminated on sheet films.

16. A combination as claimed in claim 8, wherein said bathing device is selected from the group consisting of: a bathtub, a tub shower, a shower, a spa and a pool,

17. A method for manufacturing a heated bathing device having a plastic shell the method comprising the steps of adhesively applying at least one flexible heating source in direct contact conductive heat exchange with at least one section of said shell.

18. A method as claimed in claim 17, comprising laminating said at least one heating source on said shell.

19. A method as claimed in claim 17, comprising applying a protective layer over said at least one heating source.

20. A method as claimed in claim 17, comprising operatively connecting said at least one heating membrane to a control device for controlling the heat transmitted to the shell.

21. A method as claimed in claim 17, comprising applying a wet fiberglass layer and laminating said heating source on said wet fiberglass layer.
